(19) United States
(12) Patent Application Publication
(10) Pub. No.: US 2010/0234506 A1
(43) Pub. Date: Sep. 16, 2010

(54) AQUEOUS BINDER FOR FIBROUS OR GRANULAR SUBSTRATES

(75) Inventors: Oihana Elizalde, Mannheim (DE); Kathrin Michl, Ludwigshafen (DE); Rajan Venkatesh, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/679,409

(22) PCT Filed: Oct. 6, 2008
(86) PCT No.: PCT/EP2008/063352

§ 371 Date: Mar. 22, 2010

(30) Foreign Application Priority Data
Oct. 9, 2007 (EP) 07118135.8

(51) Int. Cl. C08K 5/053; B05D 3/02; C08F 224/00; C08F 222/10

(52) U.S. Cl. 524/388; 427/385.5; 526/266; 526/318; 526/318.25

(57) ABSTRACT

Aqueous binders for fibrous and granular substrates, based on hydrophobically modified polymers.

The subject matter of the present invention relates to the use of an aqueous binder comprising

a) an addition polymer A obtained by free-radical polymerization of
0.1% to 40% by weight of at least one C3 to C30 alkene (monomer A1),
40% to 99.9% by weight of at least one ethylenically unsaturated C3 to C6 monocarboxylic acid (monomer A2),
0% to 50% by weight of at least one ethylenically unsaturated C4 to C12 dicarboxylic acid and/or of the ethylenically unsaturated dicarboxylic monoalkyl esters or dicarboxylic anhydrides obtainable from said acid (monomer A3), and
0% to 30% by weight of at least one other ethylenically unsaturated compound which is copolymerizable with the monomers A1 to A3 (monomer A4),
the monomers A1 to A4 adding up to 100% by weight (total monomer amount), and

b) a polyol compound having at least 2 hydroxyl groups (polyol B) as a binder for fibrous and/or granular substrates.

Subject matter of the present invention is likewise a process for producing shaped articles using fibrous or granular substrates and aqueous binder, and also the shaped articles themselves.

The consolidation of fibrous or granular substrates, more particularly in sheetlike structures, exemplified by fiber webs, fiberboard or chipboard panels, etc, is frequently accomplished chemically using a polymeric binder. To increase the strength, particularly the wet strength and thermal stability, in many cases binders are used which comprise crosslinkers that give off formaldehyde. As a consequence of this, however, there is a risk of unwanted formaldehyde emission.

For the purpose of avoiding formaldehyde emissions there have already been numerous alternatives proposed to the binders known to date. For instance U.S. Pat. No. 4,076,917 discloses binders which comprise carboxylic acid-containing or carboxylic anhydride-containing polymers and 6-hydroxyalkylamide crosslinkers. A disadvantage is the relatively costly and inconvenient preparation of the 13-hydroxyalkylamides.

EP-A-445578 discloses boards made of finely divided materials, such as glass fibers, for example, in which mixtures of high molecular weight polycarboxylic acids and polyhydric alcohols, alkanolamines, or polyfunctional amines act as binders.

EP-A 583086 discloses formaldehyde-free aqueous binders for producing fiber webs, more particularly glass fiber webs. The binders comprise a polycarboxylic acid having at least two carboxylic acid groups and also, if appropriate, anhydride groups, and a polyol. These binders require a phosphorus reaction accelerant in order to attain sufficient strengths on the part of the glass fiber webs. It is noted that the presence of such a reaction accelerant is vital unless a highly reactive polyol is used. Highly reactive polyols specified include β-hydroxyalkylamides.

EP-A 651088 describes corresponding binders for substrates made from cellulosic fiber. These binders necessarily comprise a phosphorus reaction accelerant.

EP-A 672920 describes formaldehyde-free binding, impregnating or coating compositions which comprise at least one polyol and a polymer which is composed to an extent of 2% to 100% by weight of an ethylenically unsaturated acid or acid anhydride comonomer. The polyols are substituted triazine, triazinetrione, benzene or cyclohexyl derivatives, and the polyol radicals are always located in positions 1, 3, and 5 of the aforementioned rings. In spite of a high drying temperature, the wet tensile strengths obtained with these binders on glass fiber webs are low.

DE-A 2214450 describes a copolymer composed of 80% to 99% by weight of ethylene and 1% to 20% by weight of maleic anhydride. Together with a crosslinking agent, the copolymer is used in powder form or in dispersion in an aqueous medium for the purpose of surface coating. The crosslinking agent used is a polyalcohol which contains amino groups. In order to bring about crosslinking, however, heating must be carried out at up to 300° C.

U.S. Pat. No. 5,143,582 discloses the production of heat-resistant nonwoven-web materials using a thermosetting heat-resistant binder. The binder is formaldehyde-free and is obtained by mixing a crosslinker with a polymer containing carboxylic acid groups, carboxylic anhydride groups or carboxylic salt groups. The crosslinker is a β-hydroxy-alkylamide or a polymer or copolymer thereof. The polymer crosslinkable with the β-hydroxyalkylamide is synthesized, for example, from unsaturated monocarboxylic or dicarboxylic acids, salts of unsaturated monocarboxylic or dicarboxylic acids, or unsaturated anhydrides. Self-curing polymers are obtained by copolymerizing the β-hydroxyalkylamides with monomers comprising carboxyl groups.

Processes for preparing addition polymers based on alkenes and other copolymerizable ethylenically unsaturated compounds are well known to the skilled worker. The copolymerization takes place essentially in the form of a solution polymerization (see, for example, A. Sen et al., Journal American Chemical Society, 2001, 123, pages 12 738 to 12 739; B. Klumperman et al., Macromolecules, 2004, 37, pages 4406 to 4416; A. Sen et al., Journal of Polymer Science, Part A: Polymer Chemistry, 2004, 42(24), pages 6175 to 6192; WO 03/042254, WO 03/091297 or EP-A 1384729) or in the form of an aqueous emulsion polymerization, this taking place more particularly on the basis of the lowest alkene, ethene (see, for example, U.S. Pat. No. 4,921,898, U.S. Pat. No. 5,070,134, U.S. Pat. No. 5,110,856, U.S. Pat. No. 5,629,370, EP-A 295727, EP-A 757065, EP-A 1114833 or DE-A 19620817).

Prior art relating to free-radically initiated aqueous emulsion polymerization using higher alkenes is as follows:

DE-A 1720277 discloses a process for preparing film-forming aqueous polymer dispersions using vinyl esters and 1-octene. The weight ratio of vinyl ester to 1-octene can be from 99:1 to 70:30. Optionally the vinyl esters can be used to a minor extent in a mixture with other copolymerizable ethylenically unsaturated compounds for the emulsion polymerization.

S. M. Samoilov in J. Macromol. Sci. Chem., 1983, A19(1), pages 107 to 122 describes the free-radically initiated aqueous emulsion polymerization of propene with different ethylenically unsaturated compounds. The outcome observed there was that the copolymerization of propene with ethylenically unsaturated compounds having strongly electron-withdrawing groups, such as chlorotrifluoroethylene, trifluoroacrylonitrile, maleic anhydride or methyl trifluoroacrylate, gave polymers having a markedly higher propene fraction, or copolymers having higher molecular weights, than when using the ethylenically unsaturated compounds typically associated with free-radically initiated aqueous emulsion polymerization, viz. vinyl acetate, vinyl chloride, methyl acrylate and/or butyl acrylate. The reasons given for this behavior include more particularly the hydrogen radical transfer reactions that are typical of the higher alkenes.

The preparation of aqueous polymer dispersions based on different, extremely water-insoluble monomers by free-radically initiated emulsion polymerization using host compounds is disclosed in U.S. Pat. No. 5,521,266 and EP-A 780401.

DE-A 102005035692 discloses the preparation of aqueous polymer dispersions based on alkenes having 5 to 12 C atoms. The alkenes having 5 to 12 C atoms are metered into the polymerization mixture under polymerization conditions.

EP-A 891430 discloses aqueous polymer systems for imparting water repellency to leather, said systems being obtained by free-radical polymerization of 20% to 90% by weight of monoethylenically unsaturated C4 to C6 dicarboxylic acids and/or their anhydrides with 5% to 50% by weight of a C2 to C6 olefin and 5% to 50% by weight of a hydrophobic ethylenically unsaturated monomer.

EP-A 670909 discloses aqueous polymer dispersions which are used as a component for fatliquoring or softening leather and which are obtained by free-radical polymerization of maleic anhydride, C12 to C30 α-olefins, and esters of acrylic acid, methacrylic acid and/or maleic acid with C12 to C30 alcohols.

Coating compositions based on a crosslinker, such as an endgroup-capped polyisocyanate or an amino resin, for example, and on an emulsion polymer based on α-olefins and ethylenically unsaturated carboxylic anhydrides, are disclosed in EP-A 450-452.

E. Witek, A. Kochanowski, E. Bortel, Polish Journal of Applied Chemistry XLVI, no. 3-4, pages 177-185 (2002), describes the use of copolymers based on long-chain α-olefins and hydrophilic monomers, such as acrylic acid and/or maleic anhydride, for example, for removing crude-oil contamination in water.

It was an object of the present invention to provide an alternative formaldehyde-free binder system for fibrous or granular substrates.

The use defined at the outset has accordingly been found.

In accordance with the invention an aqueous binder is used that comprises an addition polymer A obtained by free-radical polymerization of

0.1% to 40% by weight of at least one monomer A1,
40% to 99.9% by weight of at least one monomer A2,
0% to 50% by weight of at least one monomer A3, and
0% to 30% by weight of at least one monomer A4.

With particular advantage, aqueous binders are used which comprise an addition polymer A obtained by free-radical polymerization of

1% to 25% by weight of at least one monomer A1,
50% to 89% by weight of at least one monomer A2, and
10% to 40% by weight of at least one monomer A3,
and with particular advantage
4% to 20% by weight of at least one monomer A1,
55% to 70% by weight of at least one monomer A2, and
20% to 35% by weight of at least one monomer A3.

Monomers A 1 contemplated are C3 to C30 alkenes, preferably C6 to C18 alkenes, and more particularly C8 to C12 alkenes which can be copolymerized free-radically and which apart from carbon and hydrogen have no further elements. They include, for example, the linear alkenes propene, n-but-1-ene, n-but-2-ene, 2-methylpropene, 2-methylbut-1-ene, 3-methylbut-1-ene, 3,3-dimethyl-2-isopropylbut-1-ene, 2-methylbut-2-ene, 3-methylbut-2-ene, pent-1-ene, 2-methylpent-1-ene, 3-methylpent-1-ene, 4-methylpent-1-ene, pent-2-ene, 2-methylpent-2-ene, 3-methylpent-2-ene, 4-methylpent-2-ene, 2-ethylpent-1-ene, 3-ethylpent-1-ene, 4-ethylpent-1-ene, 2-ethylpent-2-ene, 3-ethylpent-2-ene, 4-ethylpent-2-ene, 2,4,4-trimethylpent-1-ene, 2,4,4-trimethylpent-2-ene, 3-ethyl-2-methylpent-1-ene, 3,4,4-trimethylpent-2-ene, 2-methyl-3-ethylpent-2-ene, hex-1-ene, 2-methylhex-1-ene, 3-methylhex-1-ene, 4-methylhex-1-ene, 5-methylhex-1-ene, hex-2-ene, 2-methylhex-2-ene, 3-methylhex-2-ene, 4-methylhex-2-ene, 5-methylhex-2-ene, hex-3-ene, 2-methylhex-3-ene, 3-methylhex-3-ene, 4-methylhex-3-ene, 5-methylhex-3-ene, 2,2-dimethyl-hex-3-ene, 2,3-dimethylhex-2-ene, 2,5-dimethylhex-3-ene, 2,5-dimethylhex-2-ene, 3,4-dimethylhex-1-ene, 3,4-dimethylhex-3-ene, 5,5-dimethylhex-2-ene, 2,4-dimethylhex-1-ene, hept-1-ene, 2-methylhept-1-ene, 3-methylhept-1-ene, 4-methylhept-1-ene, 5-methylhept-1-ene, 6-methylhept-1-ene, hept-2-ene, 2-methylhept-2-ene, 3-methylhept-2-ene, 4-methylhept-2-ene, 5-methylhept-2-ene, 6-methylhept-2-ene, hept-3-ene, 2-methylhept-3-ene, 3-methylhept-3-ene, 4-methylhept-3-ene, 5-methylhept-3-ene, 6-methylhept-3-ene, 6,6-dimethylhept-1-ene, 3,3-dimethylhept-1-ene, 3,6-dimethylhept-1-ene, 2,6-dimethylhept-2-ene, 2,3-dimethylhept-2-ene, 3,5-dimethylhept-2-ene, 4,5-dimethylhept-2-ene, 4,6-dimethylhept-2-ene, 4-ethylhept-3-ene, 2,6-dimethylhept-3-ene, 4,6-dimethylhept-3-ene, 2,5-dimethylhept-4-ene, oct-1-ene, 2-methyloct-1-ene, 3-methyloct-1-ene, 4-methyloct-1-ene, 5-methyloct-1-ene, 6-methyloct-1-ene, 7-methyloct-1-ene, oct-2-ene, 2-methyloct-2-ene, 3-methyloct-2-ene, 4-methyloct-2-ene, 5-methyloct-2-ene, 6-methyloct-2-ene, 7-methyloct-2-ene, oct-3-ene, 2-methyloct-3-ene, 3-methyloct-3-ene, 4-methyloct-3-ene, 5-methyloct-3-ene, 6-methyloct-3-ene, 7-methyloct-3-ene, oct-4-ene, 2-methyloct-4-ene, 3-methyloct-4-ene, 4-methyloct-4-ene, 5-methyloct-4-ene, 6-methyloct-4-ene, 7-methyloct-4-ene, 7,7-dimethyloct-1-ene, 3,3-dimethyloct-1-ene, 4,7-dimethyloct-1-ene, 2,7-dimethyloct-2-ene, 2,3-dimethyloct-2-ene, 3,6-dimethyloct-2-ene, 4,5-dimethyloct-2-ene, 4,6-dimethyloct-2-ene, 4,7-dimethyloct-2-ene, 4-ethyloct-3-ene, 2,7-dimethyloct-3-ene, 4,7-dimethyloct-3-ene, 2,5-dimethyloct-4-ene, non-1-ene, 2-methylnon-1-ene, 3-methylnon-1-ene, 4-methylnon-1-ene, 5-methylnon-1-ene, 6-methylnon-1-ene, 7-methylnon-1-ene, 8-methylnon-1-ene, non-2-ene, 2-methylnon-2-ene, 3-methylnon-2-ene, 4-methylnon-2-ene, 5-methylnon-2-ene, 6-methylnon-2-ene, 7-methylnon-2-ene, 8-methylnon-2-ene, non-3-ene, 2-methylnon-3-ene, 3-methylnon-3-ene, 4-methylnon-3-ene, 5-methylnon-3-ene, 6-methylnon-3-ene, 7-methylnon-3-ene, 8-methylnon-3-ene, non-4-ene, 2-methylnon-4-ene, 3-methylnon-4-ene, 4-methylnon-4-ene, 5-methylnon-4-ene, 6-methylnon-4-ene, 7-methylnon-4-ene, 8-methylnon-4-ene, 4,8-dimethylnon-1-ene, 4,8-dimethylnon-4-ene, 2,8-dimethylnon-4-ene, dec-1-ene, 2-methyldec-1-ene, 3-methyldec-1-ene, 4-methyldec-1-ene, 5-methyldec-1-ene, 6-methyldec-1-ene, 7-methyldec-1-ene, 8-methyldec-1-ene, 9-methyldec-1-ene, dec-2-ene, 2-methyldec-2-ene, 3-methyldec-2-ene, 4-methyldec-2-ene, 5-methyldec-2-ene, 6-methyldec-2-ene, 7-methyldec-2-ene, 8-methyldec-2-ene, 9-methyldec-2-ene, dec-3-ene, 2-methyldec-3-ene, 3-methyldec-3-ene, 4-methyldec-3-ene, 5-methyldec-3-ene, 6-methyldec-3-ene, 7-methyldec-3-ene, 8-methyldec-3-ene, 9-methyldec-3-ene, dec-4-ene, 2-methyldec-4-ene, 3-methyldec-4-ene, 4-methyldec-4-ene, 5-methyldec-4-ene, 6-methyldec-4-ene, 7-methyldec-4-ene, 8-methyldec-4-ene, 9-methyldec-4-ene, dec-5-ene, 2-methyldec-5-ene, 3-methyldec-5-ene, 4-methyldec-5-ene, 5-methyldec-5-ene, 6-methyldec-5-ene, 7-methyldec-5-ene, 8-methyldec-5-ene, 9-methyldec-5-ene, 2,4-dimethyldec-1-ene, 2,4-dimethyldec-2-ene, 4,8-dimethyldec-1-ene, undec-1-ene, 2-methylundec-1-ene, 3-methylundec-1-ene, 4-methylundec-1-ene, 5-methylundec-1-ene, 6-methylundec-1-ene, 7-methylundec-1-ene, 8-methylundec-1-ene, 9-methylundec-1-ene, 10-methylundec-1-ene, undec-2-ene, 2-methylundec-2-ene, 3-methylundec-2-ene, 4-methylundec-2-ene, 5-methylundec-2-ene, 6-methylundec-2-ene, 7-methylundec-2-ene, 8-methylundec-2-ene, 9-methylundec-2-ene, 10-methylundec-2-ene, undec-3-ene, 2-methylundec-3-ene, 3-methylundec-3-ene, 4-methylundec-3-ene, 5-methylundec-3-ene, 6-methylundec-3-ene, 7-methylundec-3-ene, 8-methylundec-3-ene, 9-methylundec-3-ene, 10-methylundec-3-ene, undec-4-ene, 2-methylundec-4-ene, 3-methylundec-4-ene, 4-methylundec-4-ene, 5-methylundec-4-ene, 6-methylundec-4-ene, 7-methylundec-4-ene, 8-methylundec-4-ene, 9-methylundec-4-ene, 10-methylundec-4-ene, undec-5-ene, 2-methylundec-5-ene, 3-methylundec-5-ene, 4-methylundec-5-ene, 5-methylundec-5-ene, 6-methylundec-5-ene, 7-methylundec-5-ene, 8-methylundec-5-ene, 9-methylundec-5-ene, 10-methylundec-5-ene, dodec-1-ene, dodec-2-ene, dodec-3-ene, dodec-4-ene, dodec-5-ene, dodec-6-ene, 4,8-dimethyldec-1-ene, 4-ethyldec-1-ene, 6-ethyldec-1-ene, 8-ethyldec-1-ene, 2,5,8-trimethylnon-1-ene, tridec-1-ene, tridec-2-ene, tridec-3-ene, tridec-4-ene, tridec-5-ene, tridec-6-ene, 2-methyldodec-1-ene, 11-methyldodec-1-ene, 2,5-dimethylundec-2-ene, 6,10-dimethylundec-1-ene, tetradec-1-ene, tetradec-2-ene, tetradec-3-ene, tetradec-4-ene, tetradec-5-ene, tetradec-6-ene, tetradec-7-ene, 2-methyltridec-1-ene, 2-ethyldodec-1-ene, 2,6,10-trimethylundec-1-ene, 2,6-dimethyldodec-2-ene, 11-methyltridec-1-ene, 9-methyltridec-1-ene, 7-methyltridec-1-ene, 8-ethyldodec-1-ene, 6-ethyldodec-1-ene, 4-ethyldodec-1-ene, 6-butyldec-1-ene, pentadec-1-ene, pentadec-2-ene, pentadec-3-ene, pentadec-4-ene, pentadec-5-ene, pentadec-6-ene, pentadec-7-ene, 2-methyltetradec-1-ene, 3,7,11-trimethyldodec-1-ene, 2,6,10-trimethyldodec-1-ene, hexadec-1-ene, hexadec-2-ene, hexadec-3-ene, hexadec-4-ene, hexadec-5-ene, hexadec-6-ene, hexadec-7-ene, hexadec-8-ene, 2-methylpentadec-1-ene, 3,7,11-trimethyltridec-1-ene, 4,8,12-trimethyltridec-1-ene, 11-methylpentadec-1-ene, 13-methylpentadec-1-ene, 7-methylpentadec-1-ene, 9-methylpentadec-1-ene, 12-ethyltetradec-1-ene, 8-ethyltetradec-1-ene, 4-ethyltetradec-1-ene, 8-butyldodec-1-ene, 6-butyldodec-1-ene, heptadec-1-ene, heptadec-2-ene, heptadec-3-ene, heptadec-4-ene, heptadec-5-ene, heptadec-6-ene, heptadec-7-ene, heptadec-8-ene, 2-methylhexadec-1,4,8-ene, 12-trimethyltetradec-1-ene, octadec-1-ene, octadec-2-ene, octadec-3-ene, octadec-4-ene, octadec-5-ene, octadec-6-ene, octadec-7-ene, octadec-8-ene, octadec-9-ene, 2-methylheptadec-1-ene, 13-methylheptadec-1-ene, 10-butyltetradec-1-ene, 6-butyltetradec-1-ene, 8-butyltetradec-1-ene, 10-ethylhexadec-1-ene, nonadec-1-ene, nonadec-2-ene, 1-methyloctadec-1-ene, 7,11,15-trimethyl-hexadec-1-ene, eicos-1-ene, eicos-2-ene, 2,6,10,14-tetramethylhexadec-2-ene, 3,7,11,15-tetramethylhexadec-2-ene, 2,7,11,15-tetramethylhedec-1-ene, docos-1-ene, docos-2-ene, docos-7-ene, 4,9,13,17-tetramethyloctadec-1-ene, tetracos-1-ene, tetracos-2-ene, tetracos-9-ene, hexacos-1-ene, hexacos-2-ene, hexacos-9-ene, triacont-1-ene, dotriacont-1-ene or tritriacont-1-ene, and also the cyclic alkenes cyclopentene, 2-methylcyclopent-1-ene, 3-methylcyclopent-1-ene, 4-methylcyclopent-1-ene, 3-butylcyclopent-1-ene, vinylcyclopentane, cyclohexene, 2-methylcyclohex-1-ene, 3-methylcyclohex-1-ene, 4-methylcyclohex-1-ene, 1,4-dimethylcyclohex-1-ene, 3,3,5-trimethylcyclohex-1-ene, 4-cyclopentylcyclohex-1-ene, vinylcyclohexane, cycloheptene, 1,2-dimethylcyclohept-1-ene, cyclooctene, 2-methylcyclooct-1-ene, 3-methylcyclooct-1-ene, 4-methylcyclooct-1-ene, 5-methylcyclooct-1-ene, cyclononene, cyclodecene, cycloundecene, cyclododecene, bicyclo[2.2.1]hept-2-ene, 5-ethyl-bicyclo[2.2.1]hept-2-ene, 2-methylbicyclo[2.2.2]oct-2-ene, bicyclo[3.3.1]non-2-ene or bicyclo[3.2.2]non-6-ene. It will be appreciated that mixtures of aforementioned monomers A can also be used.

Preference is given to using the 1-alkenes, examples being propene, 2-methylpropene, but-1-ene, pent-1-ene, hex-1-ene, hept-1-ene, oct-1-ene, non-1-ene, dec-1-ene, undec-1-ene, dodec-1-ene, 2,4,4-trimethylpent-1-ene, 2,4-dimethylhex-1-ene, 6,6-dimethylhept-1-ene, 2-methyloct-1-ene, tridec-1-ene, tetradec-1-ene, hexadec-1-ene, heptadec-1-ene, octadec-1-ene, nonadec-1-ene, eicos-1-ene, docos-1-ene, tetracos-1-ene, 2,6-dimethyldodec-1-ene, 6-butyldec-1-ene, 4,8,12-trimethyldec-1-ene or 2-methylheptadec-1-ene. Advantageously, at least one monomer A1 used is an alkene having 6 to 18 carbon atoms, preferably a 1-alkene having 8 to 12 carbon atoms. Preference is given more particularly to using oct-1-ene, non-1-ene, dec-1-ene, undec-1-ene and/or dodec-1-ene, with oct-1-ene and dodec-1-ene being particularly preferred.

The amount of monomers A1 in the preparation of the polymer A is 0.1% to 40%, preferably 1% to 25%, and with more particular preference 4% to 20% by weight, based in each case on the total monomer amount.

Monomers A2 contemplated are ethylenically unsaturated monocarboxylic acids, more particularly α,β-monoethylenically unsaturated monocarboxylic acids, of 3 to 6 carbon atoms, and also their water-soluble salts, more particularly their alkali metal salts or ammonium salts, such as, for example, acrylic acid, methacrylic acid, ethyl acrylic acid, allyl acetic acid, crotonic acid and/or vinyl acetic acid, and also the ammonium, sodium or potassium salts of the aforementioned acids. Particularly preference is given to acrylic acid and methacrylic acid, with acrylic acid being more particularly preferred.

The amount of monomers A2 in the preparation of the polymer A is 40% to 99.9%, preferably 50% to 89%, and with more particular preference 55% to 70% by weight, based in each case on the total monomer amount.

Monomers A3 contemplated are ethylenically unsaturated dicarboxylic acids, more particularly α,β-monoethylenically unsaturated dicarboxylic acids, of 4 to 12 carbon atoms, and also their water-soluble salts, more particularly their alkali metal salts or ammonium salts, and/or the ethylenically unsaturated dicarboxylic acid monoalkyl esters that are obtainable from the ethylenically unsaturated dicarboxylic acids of 4 to 12 carbon atoms, more particularly their C1 to C6 monoalkyl esters, examples being their monomethyl, monoethyl, monopropyl, monoisopropyl, monobutyl, monopentyl or monohexyl esters and also the corresponding obtainable dicarboxylic anhydrides, such as, for example, maleic acid, fumaric acid, itaconic acid, methylmaleic acid, 1,2,3,6-tetrahydrophthalic acid, and the ammonium, sodium or potassium salts of the aforementioned acids, monomethyl, monoethyl, and monopropyl maleate, fumarate, itaconate, methyl maleate, and 1,2,3,6-tetrahydrophthalate, maleic anhydride, itaconic anhydride, methylmaleic anhydride or 1,2,3,6-tetrahydrophthalic anhydride. Particular preference is given to maleic anhydride, methylmaleic anhydride, monomethyl maleate, itaconic acid, itaconic anhydride, 1,2,3,6-tetrahydrophthalic acid and/or 1,2,3,6-tetrahydrophthalic anhydride, with maleic anhydride being more particularly preferred.

The amount of monomers A3 in the preparation of the polymer A is 0% to 50%, preferably 10% to 40%, and with more particular preference 20% to 35% by weight, based in each case on the total monomer amount.

Monomers A4 contemplated are all those ethylenically unsaturated compounds which can easily be copolymerized free-radically with the monomers A1 to A3, such as, for example, vinylaromatic monomers, such as styrene, α-methylstyrene, o-chlorostyrene or vinyltoluenes, vinyl halides, such as vinyl chloride or vinylidene chloride, esters of vinyl alcohol and monocarboxylic acids having 1 to 18 C atoms, such as vinyl acetate, vinyl propionate, vinyl n-butyrate, vinyl laurate, and vinyl stearate, esters of α,β-monoethylenically unsaturated monocarboxylic and dicarboxylic acids preferably of 3 to 6 C atoms, such as, more particularly, acrylic acid, methacrylic acid, maleic acid, fumaric acid, and itaconic acid, with alkanols having generally 1 to 12, preferably 1 to 8, and more particularly 1 to 4 C atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate, nitriles of α,β-monoethylenically unsaturated carboxylic acids, such as acrylonitrile, methacrylonitrile, fumaronitrile, maleonitrile, and also C₄₋₈ conjugated dienes, such as 1,3-butadiene (butadiene) and isoprene. The stated monomers generally form the principal monomers, which, based on the total amount of monomers A4, account for a fraction of ≧50%, preferably ≧80%, and with more particular preference ≧90% by weight, or even form the total amount of the monomers A4. As a general rule these monomers are of only moderate to low solubility in water under standard conditions [20° C., 1 atm (absolute)].

Monomers A4 which have a heightened water-solubility under the above-stated conditions are those which comprise either at least one sulfonic acid group and/or its corresponding anion, or at least one amino, amido, ureido or N-heterocyclic group and/or the ammonium derivatives thereof that are alkylated or protonated on the nitrogen. Mention may be made exemplarily of acrylamide and methacrylamide, and also vinylsulfonic acid, 2-acrylamido-2-methylpropanesulfonic acid, styrenesulfonic acid, and their water-soluble salts, and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, and 2-(1-imidazoline-2-onyl)ethyl methacrylate. Normally the aforementioned water-soluble monomers A4 are used only as modifying monomers, in amounts of ≧10%, preferably ≧5%, and with more particular preference ≧3% by weight, based in each case on the total amount of monomers A4.

Monomers A4 which typically enhance the internal strength of the films formed from a polymer matrix normally contain at least one epoxy group, at least one carbonyl group or at least two nonconjugated ethylenically unsaturated double bonds. Examples of such monomers are monomers containing two vinyl radicals, monomers containing two vinylidene radicals, and monomers containing two alkenyl radicals. Particularly advantageous in this context are the diesters of dihydric alcohols with α,β-monoethylenically unsaturated monocarboxylic acids, among which acrylic acid and methacrylic acid are preferred. Examples of such monomers containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates, and ethylene glycol dimethacrylate, 1,2-propylene glycol dimethacrylate, 1,3-propylene glycol dimethacrylate, 1,3-butylene glycol dimethacrylate, and 1,4-butylene glycol dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Frequently the aforementioned crosslinking monomers A4 are used in amounts of ≧10% by weight, but preferably in amounts of ≧3% by weight, based in each case on the total amount of monomers A4. With more particular preference, however, no such crosslinking monomers A4 at all are used in preparing the polymer A.

Advantageously, for the purpose of preparing the polymer A, monomers A4 used are those monomers or monomer mixtures which comprise
50% to 100% by weight of esters of acrylic and/or methacrylic acid with alkanols containing 1 to 12 carbon atoms, or
50% to 100% by weight of styrene and/or butadiene, or
50% to 100% by weight of vinyl chloride and/or vinylidene chloride, or
50% to 100% by weight of vinyl acetate and/or vinyl propionate.

The amount of monomers A4 in the preparation of the polymer A is 0% to 30% by weight and preferably 0% to 15%, based in each case on the total monomer amount. With more particular preference no monomers A4 are used.

In accordance with the invention it is optionally possible to include in each case a portion or the total amount of the monomers A1 to A4 in the initial charge to the polymerization vessel. It is also possible, however, in each case to meter in optionally the total amount or the respective remainder, of the monomers A1 to A4 during the polymerization reaction. The total amounts or the optionally remainders, of monomers A1 to A4 may in that case be metered discontinuously, in one or more portions, or continuously, with constant or changing volume flows, to the polymerization vessel. Frequently at least a portion of the monomers A1 and/or A3, and, advantageously, monomer A3 exclusively, in the polymerization medium, is included in the initial charge before the polymerization reaction is initiated.

The preparation of the polymers A is familiar in principle to the skilled worker and is accomplished more particularly by means of free-radically initiated solution polymerization, in water, for example, or in an organic solvent (see, for example, A. Echte, Handbuch der Technischen Polymerchemie, chapter 6, VCH, Weinheim, 1993 or B. Vollmert, Grundriss der Makromolekularen Chemie, volume 1, E. Vollmert Verlag, Karlsruhe, 1988).

The free-radically initiated solution polymerization of the monomers A1 to A4 takes place preferably in a protic or an aprotic organic solvent, with aprotic solvents being more particularly preferred. Suitable aprotic organic solvents include all organic solvents which under polymerization conditions comprise no ionizable proton in the molecule or have a pKa which is greater than that of water. Examples of such solvents are aromatic hydrocarbons, such as toluene, o-, m-, and p-xylene, and isomer mixtures, and also ethylbenzene, linear or cyclic aliphatic hydrocarbons, such as pentane, hexane, heptane, octane, nonane, dodecane, cyclohexane, cyclooctane, methylcyclohexane, and also mixtures of the stated hydrocarbons, and petroleum fractions which comprise no polymerizable monomers, or aliphatic or aromatic halogenated hydrocabons, such as chloroform, carbon tetrachloride, hexachloroethane, dichloroethane, tetrachloroethane, chlorobenzene, and also liquid C1 and C2 hydrofluorochlorocarbons, aliphatic C2 to C5 nitriles, such as acetonitrile, propionitrile, butyronitrile or valeronitrile, linear or cyclic aliphatic C3 to C7 ketones, such as acetone, methyl ethyl ketone, methyl isobutyl ketone, 2- and 3-hexanone, 2-, 3-, and 4-heptanone, cyclopentanone, cyclohexanone, linear or cyclic aliphatic ethers, such as diisopropyl ether, 1,3- or 1,4-dioxane, tetrahydrofuran or ethylene glycol dimethyl ether, carbonates, such as diethyl carbonate, and also esters of aliphatic C1 to C5 carboxylic acids or aromatic carboxylic acids with aliphatic C1 to C5 alcohols, such as ethyl formate, n-propyl formate, isopropyl formate, n-butyl formate, isobutyl formate, tert-butyl formate, amyl formate, methyl acetate, ethyl acetate, n-propyl acetate, isopropyl acetate, n-butyl acetate, isobutyl acetate, tert-butyl acetate, amyl acetate, methyl propionate, ethyl propionate, n-propyl propionate, isopropyl propionate, n-butyl propionate, isobutyl propionate, tert-butyl propionate, amyl propionate, methyl butyrate, ethyl butyrate, n-propyl butyrate, isopropyl butyrate, n-butyl butyrate, isobutyl butyrate, tert-butyl butyrate, amyl butyrate, methyl valerate, ethyl valerate, n-propyl valerate, isopropyl valerate, n-butyl valerate, isobutyl valerate, tert-butyl valerate, amyl valerate, methyl benzoate or ethyl benzoate, and also lactones, such as butyrolactone, valerolactone or caprolactone.

Preference, however, is given to selecting those aprotic organic solvents in which the particular free-radical initiators used dissolve well. More particularly, use is made of those aprotic organic solvents in which not only the free-radical initiators but also the polymers A dissolve well. More particular preference is given to selecting those aprotic organic solvents which additionally can be separated in a simple way from the resulting polymer A solution, such as, for example, by distillation, inert-gas stripping and/or steam distillation. Preferred examples of such are esters of aliphatic C1 to C5 carboxylic acids or aromatic carboxylic acids with aliphatic C1 to C5 alcohols, such as ethyl formate, n-propyl formate, isopropyl formate, n-butyl formate, isobutyl formate, tert-butyl formate, amyl formate, methyl acetate, ethyl acetate, n-propyl acetate, isopropyl acetate, n-butyl acetate, isobutyl acetate, tert-butyl acetate, amyl acetate, methyl propionate, ethyl propionate, n-propyl propionate, isopropyl propionate, n-butyl propionate, isobutyl propionate, tert-butyl propionate, amyl propionate, methyl butyrate, ethyl butyrate, n-propyl butyrate, isopropyl butyrate, linear or cyclic aliphatic ethers, such as diisopropyl ether, 1,3- or 1,4-dioxane, tetrahydrofurane or ethylene glycol dimethyl ether, methyl glycol acetate, diethyl carbonate, linear or cyclic aliphatic C3 to C7 ketones, such as acetone, methyl ethyl ketone, methyl isobutyl ketone, 2- or 3-hexanone, 2-, 3- or 4-heptanone, cyclopentanone, or cyclohexanone. Particularly preferred solvents are the abovementioned esters of aliphatic C1 to C5 carboxylic acids or aromatic carboxylic acids with aliphatic C1 to C5 alcohols, but more particularly ethyl acetate and ethyl butyrate, and also C4 to C6 ketones, more particularly methyl ethyl ketone. It is advantageous if the solvent has a boiling point under atmospheric pressure (1 atm=1.013 bar) ≦140° C., frequently ≦125° C., and more particularly ≦100° C., or forms a low-boiling azeotropic water/solvent mixture with water. It will be appreciated that a mixture of two or more solvents can also be used.

The amount of solvent in the preparation of the polymer A is 40 to 9900 parts, preferably 70 to 400 parts, and with more particular preference 80 to 200 parts by weight, based in each case on 100 parts by weight of total monomers.

In accordance with the invention it is optionally possible to include a portion or the entirety of solvent in the initial charge to the polymerization vessel. It is, however, also possible to meter in the entirety or any remainder of solvent during the polymerization reaction. In that case the entirety or the optional remainder of solvent can be metered into the polymerization vessel discontinuously, in one or more portions, or continuously, with constant or changing volume flows. Advantageously a portion of the solvent as polymerization medium is included in the initial charge to the polymerization vessel before the polymerization reaction is initiated, and the remainder is metered in together with the monomers A1 to A4 and the free-radical initiator during the polymerization reaction.

The free-radical polymerization of the monomers A1 to A4 is initiated and maintained by means of what are known as free-radical initiators. Free-radical initiators (initiators which form free radicals) that are suitable are preferably all those radical-forming initiators which have a half-life at polymerization temperature of ≧4 hours, more particularly ≧1 hour, and advantageously ≧30 minutes.

Where the polymerization of the monomers A1 to A4 is carried out in an aqueous medium, use is made of what are known as water-soluble free-radical initiators, which the skilled worker typically uses in the case of free-radically initiated aqueous emulsion polymerization. If, on the other hand, the polymerization of the monomers is carried out in an organic solvent, then what are known as oil-soluble free-radical initiators are used, which the skilled worker typically uses in the case of free-radically initiated solution polymerization.

Examples that may be mentioned of oil-soluble free-radical initiators include dialkyl and diaryl peroxides, such as di-tert-amyl peroxide, dicumyl peroxide, bis(tert-butylperoxyisopropyl)benzene, 2,5-bis(tert-butylperoxy)-2,5-dimethylhexane, tert-butylcumene peroxide, 2,5-bis(tert-butylperoxy)-2,5-dimethyl-3-hexene, 1,1-bis(tert-butylperoxy)-3,3,5-trimethylcyclohexane, 1,1-bis(tert-butylperoxy)cyclohexane, 2,2-bis(tert-butylperoxy)butane or di-tert-butyl peroxide, aliphatic and aromatic peroxyesters, such as cumyl peroxyneodecanoate, 2,4,4-trimethylpentyl 2-peroxyneodecanoate, tert-amyl peroxyneodecanoate, tert-butyl peroxyneodecanoate, tert-amyl peroxypivalate, tert-butyl peroxypivalate, tert-amyl peroxy-2-ethylhexanoate, tert-butyl peroxy-2-ethylhexanoate, tert-butyl peroxydiethylacetate, 1,4-bis(tert-butylperoxy)cyclohexane, tert-butyl peroxyisobutanoate, tert-butyl peroxy-3,5,5-trimethylhexanoate, tert-butyl peroxyacetate, tert-amyl peroxybenzoate or tert-butyl peroxybenzoate, dialkanoyl and dibenzoyl peroxides, such as diisobutanoyl peroxide, bis(3,5,5-trimethylhexanoyl)peroxide, dilauroyl peroxide, didecanoyl peroxide, 2,5-bis(2-ethylhexanoylperoxy)-2,5-dimethylhexane or dibenzoyl peroxide, and also peroxycarbonates, such as bis(4-tert-butylcyclohexyl)peroxydicarbonate, bis(2-ethylhexyl)peroxydicarbonate, di-tert-butyl peroxydicarbonate, diacetyl peroxydicarbonate, dimyristyl peroxydicarbonate, tert-butyl peroxyisopropyl carbonate or tert-butyl peroxy-2-ethylhexyl carbonate. Examples of readily oil-soluble azo initiators used include 2,2″-azobis(isobutyronitrile), 2,2″-azobis(2,4-dimethyl-valeronitrile) or 4,4″-azobis(4-cyanopentanoic acid).

A preferred oil-soluble free-radical initiator is a compound selected from the group comprising tert-butyl peroxy-2-ethylhexanoate (Trigonox® 21; Trigonox® brand name of Akzo Nobel), tert-amyl peroxy-2-ethylhexanoate (Trigonox® 121), tert-butyl peroxybenzoate (Trigonox® C), tert-amyl peroxybenzoate, tert-butyl peroxyacetate (Trigonox® F), tert-butyl peroxy-3,5,5-trimethylhexanoate (Trigonox® 42 S), tert-butyl peroxyisobutanoate, tert-butyl peroxydiethylacetate (Trigonox® 27), tert-butyl peroxypivalate (Trigonox® 25), tert-butyl peroxyisopropyl carbonate (Trigonox® BPIC), 2,5-dimethyl-2,5-di(tert-butylperoxy)hexane (Trigonox® 101), di-tert-butyl peroxide (Trigonox® B), cumyl hydroperoxide (Trigonox® K) and tert-butyl peroxy-2-ethylhexyl carbonate (Trigonox® 117). It will be appreciated that it is also possible to use mixtures of aforementioned oil-soluble free-radical initiators.

The amount of free-radical initiator used is generally 0.01% to 10%, preferably 0.1% to 8%, and with more particular preference 1% to 6% by weight, based in each case on the total monomer amount.

In accordance with the invention it is optionally possible to include a portion or the entirety of free-radical initiator in the initial charge to the polymerization vessel. It is also possible, however, to meter in the entirety or the optional remainder of free-radical initiator during the polymerization reaction. The entirety or the remainder of free-radical initiator may in that case be optionally metered into the polymerization vessel discontinuously, in one or more portions, or continuously, with constant or changing volume flows. With more particular advantage the free-radical initiator is metered during the polymerization reaction continuously, with constant volume flow—more particularly in the form of a solution of the free-radical initiator with the solvent used.

Polymer A advantageously has a weight-average molecular weight ≧1000 g/mol and ≦100 000 g/mol. It is advantageous if the weight-average molecular weight of polymer A is ≦50 000 g/mol or ≦40 000 g/mol. With more particular advantage polymer A has a weight-average molecular weight ≧3000 g/mol and ≦40 000 g/mol. With particular advantage the weight-average molecular weight is situated in the range ≧3000 and ≦25 000 g/mol. The setting of the weight-average molecular weight during the preparation of polymer A is familiar to the skilled worker and is advantageously accomplished by free-radically initiated aqueous solution polymerization in the presence of free-radical chain-transfer compounds, referred to as free-radical chain regulators. The determination of the weight-average molecular weight is also familiar to the skilled worker and is accomplished, for example, by means of gel permeation chromatography.

Examples of suitable free-radical chain regulators are organic compounds comprising sulfur in bonded form. They include, for example, mercapto compounds, such as mercaptoethanol, mercaptopropanol, mercaptobutanol, mercaptoacetic acid, mercaptopropionic acid, butyl mercaptan, and dodecyl mercaptan. Further free-radical chain regulators are familiar to the skilled worker. If the polymerization is carried out in the presence of free-radical chain regulators, it is common to use 0.01% to 10% by weight, based on the total monomer amount.

In accordance with the invention it is possible to include at least a portion of the free-radical chain regulator in the initial charge to the polymerization medium and to add the optional remainder to the polymerization medium after the free-radical polymerization reaction has been initiated, that addition taking place discontinuously in one portion, discontinuously in two or more portions, and also continuously with constant or changing volume flows. Frequently the total amount of the free-radical chain regulator is added continuously, together with the monomers A1 to A4, during the polymerization reaction.

By controlled variation of the nature and amount of the monomers A1 to A4 it is possible in accordance with the invention for the skilled worker to prepare polymers A which have a glass transition temperature or a melting point in the range from −60 to 270° C. Advantageously in accordance with the invention the glass transition temperature of the polymer A is ≧−20° C. and ≦110° C., and preferably ≧20° C. and ≦105° C.

The glass transition temperature, T_{g}, is the limiting value of the glass transition temperature to which said temperature tends with increasing molecular weight, according to G. Kanig (Kolloid-Zeitschrift & Zeitschrift für Polymere, vol. 190, p. 1, equation 1). The glass transition temperature or melting point is determined by the DSC method (differential scanning calorimetry, 20 K/min, midpoint measurement, DIN 53765).

According to Fox (T. G. Fox, Bull. Am. Phys. Soc. 1956 [Ser. II] 1, page 123, and in accordance with Ullmann's Encyclopädie der technischen Chemie, vol. 19, page 18, 4th edition, Verlag Chemie, Weinheim, 1980) the glass transition temperature of copolymers with no more than low degrees of crosslinking is given in good approximation by:

1/T_{g}=x¹/T_{g}¹+x²/T_{g}²+ . . . xⁿ/T_{g}ⁿ,

where x¹, x², . . . xⁿ are the mass fractions of the monomers 1, 2, . . . n and T_{g}ⁿ, T_{g}², . . . T_{g}ⁿ are the glass transition temperatures of the polymers synthesized in each case only from one of the monomers 1, 2, . . . n, in degrees Kelvin. The T_{g} values for the homopolymers of the majority of monomers are known and are listed, for example, in Ullmann's Encyclopedia of Industrial Chemistry, 5th edition, vol. A21, page 169, VCH Weinheim, 1992; further sources of homopolymer glass transition temperatures include, for example, J. Brandrup, E. H. Immergut, Polymer Handbook, 1st ed., J. Wiley, New York 1966, 2nd ed. J. Wiley, New York 1975, and 3rd ed. J. Wiley, New York 1989).

The polymer A solutions obtained in accordance with the invention typically have polymer solids contents of ≧10% and ≦70%, frequently ≧20% and ≦65%, and often 40% and ≦60% by weight, based in each case on the corresponding polymer A solution.

Depending on the free-radical initiator used, the free-radically initiated polymerization takes place typically at temperatures in the range from 40 to 180° C., preferably from 50 to 150° C., and more particularly from 60 to 110° C. As soon as the temperature during the polymerization reaction is above the boiling point of the solvent and/or of one of the monomers A1 to A4, the polymerization is carried out advantageously under pressure (>1 atm absolute). The temperature and pressure conditions are familiar to the skilled worker or can be determined by him or her in a few routine experiments.

The polymers A can be prepared in the typical polymerization devices. Examples of those used for this purpose include glass flasks (laboratory) or stirred tanks (industrial scale) equipped with an anchor, blade, impeller, cross-arm, MIG or multistage pulsed counter-current stirrer. In the case more particularly of polymerization in the presence of only small amounts of solvent, it may also be advantageous to carry out the polymerization in typical one-screw of two-screw (co-rotating or counter-rotating) kneader reactors, such as those, for example, from the company List or Buss SMS.

Where polymer A is prepared in an organic solvent, at least some of the organic solvent, advantageously ≧50% or ≧90% by weight, and, with more particular advantage, all of the organic solvent, is generally removed, and the polymer A is taken up in water, advantageously in deionized water. The corresponding methods are familiar to the skilled worker. Thus, for example, the switching of the solvent for water can be accomplished by distilling off at least some of the solvent, advantageously all of it, in one or more stages, at, for example, atmospheric pressure (1 atm absolute) or subatmospheric pressure (<1 atm absolute), and replacing it by water. Frequently it may be advantageous to remove the solvent from the solution by introducing steam and at the same time to replace it by water. This is more particularly the case when the organic solvent has a certain steam volatility.

Also comprised in accordance with the invention, therefore, is an addition polymer A obtainable by free-radical polymerization of

0.1% to 40% by weight of at least one monomer A1,
40% to 99.9% by weight of at least one monomer A2,
0% to 50% by weight of at least one monomer A3, and
0% to 30% by weight of at least one monomer A4,
the monomers A1 to A4 adding up to 100% by weight.

Likewise comprised in accordance with the invention, therefore, is an aqueous binder comprising

a) an addition polymer A obtained by free-radical polymerization of
0.1% to 40% by weight of at least one monomer A1,
40% to 99.9% by weight of at least one monomer A2,
0% to 50% by weight of at least one monomer A3, and
0% to 30% by weight of at least one monomer A4,
   the monomers A1 to A4 adding up to 100% by weight, and
   b) a polyol compound having at least 2 hydroxyl groups (polyol B).

The aqueous binder used in accordance with the invention comprises not only the polymer A but also a polyol B which has at least 2 hydroxyl groups. It is advantageous in this context to use those polyols B which are not volatile at the temperatures of drying and/or curing and which therefore have a correspondingly low vapor pressure.

The polyol B may in principle be a compound having a molecular weight ≦1000 g/mol or a polymeric compound having a molecular weight >1000 g/mol. Examples of polymeric compounds having at least 2 hydroxyl groups include polyvinyl alcohol, partly hydrolyzed polyvinyl acetate, homopolymers or copolymers of hydroxyalkyl acrylates or hydroxyalkyl methacrylates, such as hydroxyethyl acrylate or methacrylate or hydroxypropyl acrylate or methacrylate, for example. Examples of further polymeric polyols B are given in WO 97/45461, page 3, line 3 to page 14, line 33, among other publications.

Compounds contemplated as polyol B with a molecular weight ≦1000 g/mol include all those organic compounds which have at least 2 hydroxyl groups and a molecular weight ≦1000 g/mol. Mention may be made exemplarily of ethylene glycol, 1,2-propylene glycol, glycerol, 1,2- and 1,4-butanediol, pentaerythritol, trimethylolpropane, sorbitol, sucrose, glucose, 1,2-, 1,3-, and 1,4-dihydroxybenzene, 1,2,3-trihydroxybenzene, 1,2-, 1,3-, and 1,4-dihydroxycyclohexane, and also, preferably, alkanolamines, such as, for example compounds in the general formula I

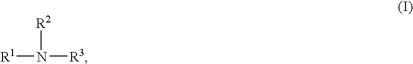

in which R¹ is an H atom, a C₁-C₁₀ alkyl group or a C₂-C₁₀ hydroxyalkyl group, and R² and R³ are a C₂-C₁₀ hydroxyalkyl group.

With particular preference R² and R³ independently of one another are a C₂-C₅ hydroxyalkyl group, and R¹ is an H atom, a C₁-C₅ alkyl group or a C₂-C₅ hydroxyalkyl group.

Compounds of the formula I include more particularly diethanolamine, triethanolamine, diisopropanolamine, triisopropanolamine, methyldiethanolamine, butyldiethanolamine and/or methyldiisopropanolamine.

Examples of further polyols B having a molecular weight ≦1000 g/mol are likewise found in WO 97/45461, page 3, line 3 to page 14, line 33.

The polyol B is preferably selected from the group comprising diethanolamine, triethanolamine, diisopropanolamine, triisopropanolamine, methyldiethanolamine, butyldiethanolamine and/or methyldiisopropanolamine, with triethanolamine being more particularly preferred.

For the aqueous binders which can be used in accordance with the invention, the polymer A and the polyol B are used preferably in a quantitative ratio to one another such that the weight ratio of polymer A to polyol B is 1:10 to 100:1, advantageously 1:5 to 50:1, and with more particular advantage 1:1 to 10:1.

With more particular advantage the amounts of polymer A and polyol B are chosen such that the ratio of the number of equivalents of carboxyl groups of the polymer A to the number of equivalents of hydroxyl groups of the polyol B is 100:1 to 1:3, preferably 50:1 to 1:2, and more preferably 10:1 to 1:1 (the anhydride groups in this case being counted as 2 carboxyl groups).

The preparation of the aqueous binders which can be used in accordance with the invention is familiar to the skilled worker and is accomplished, for example, in a simple way by addition of the polyol B to the aqueous solution of the polymer A.

The aforementioned aqueous binders comprise preferably less than 1.5% by weight, more particularly less than 1.0%, more preferably less than 0.5%, and very preferably less than 0.3%, more particularly less than 0.1%, by weight, based on the sum of polymer A and polyol B (solid/solid), of a phosphorus reaction accelerant. Phosphorus reaction accelerants are disclosed in, for example, EP-A 583086 and EP-A 651088. They include, more particularly, alkali metal hypophosphites, phosphites, polyphosphates, and dihydrogen phosphates, polyphosphoric acid, hypophosphoric acid, phosphoric acid, alkylphosphinic acid, or oligomers and/or polymers of these salts and acids.

The aqueous binders preferably comprise no phosphorus reaction accelerants or no amounts of a phosphorus compound that are active in accelerating the reaction. The binders of the invention may, however, comprise esterification catalysts familiar to the skilled worker, such as, for example, sulfuric acid or p-toluenesulfonic acid, or titanates or zirconates.

Furthermore, the aqueous binders of the invention may also comprise further, optional auxiliaries familiar to the skilled worker, such as, for example, what are known as thickeners, defoamers, neutralizing agents, buffer substances, preservatives, finely divided inert fillers, such as aluminum silicates, quartz, precipitated or fumed silica, light or heavy spar, talc or dolomite, coloring pigments, such as titanium white, zinc white or black iron oxide, adhesion promoters and/or flame retardants.

Where the aqueous binders of the invention are to be used as binders for mineral fibers and/or glass fibers or webs produced from them, advantageously ≧0.001% and ≦5% by weight, and with more particular advantage ≧0.05% and ≦2% by weight, based on the total amount of polymer A and polyol B, of at least one silicon adhesion promoter is added to the aqueous binders, some examples being an alkoxy silane, such as methyltrimethoxysilane, n-propyltrimethoxysilane, n-octyltrimethoxysilane, n-decyl-triethoxysilane, n-hexadecyltrimethoxysilane, dimethyldimethoxysilane, trimethyl-methoxysilane, 3-acetoxypropyltrimethoxysilane, 3-aminopropyltrimethoxysilane, 3-aminopropyltriethoxysilane, 3-chloropropyltrimethoxysilane, 3-glycidyloxypropyl-trimethoxysilane, 3-mercaptopropyltrimethoxysilane and/or phenyltrimethoxysilane, with particular preference being given to functionalized alkoxy silanes, such as 3-acetoxypropyltrimethoxysilane, 3-aminopropyltrimethoxysilane, 3-aminopropyl-triethoxysilan, 3-chloropropyl-trimethoxysilane, 3-glycidyloxypropyltrimethoxysilane and/or 3-mercaptopropyl-trimethoxysilane.

The aqueous binders which can be used in accordance with the invention typically have solids contents (formed from the sum of polymer A and polyol B reckoned as solids) of ≧5% and ≦70%, frequently ≧10% and ≦65%, and often ≧15% and ≦55%, by weight, based in each case on the aqueous binder.

The aqueous binders which can be used in accordance with the invention typically have pH values (measured at 23° C.; diluted with deionized water to a solids content of 10% by weight) in the range of ≧1 and ≦10, advantageously ≧2 and ≦6, and with more particular advantage ≧3 and ≦5. The pH in this case may be set using all of the basic compounds that are familiar to the skilled worker. It is advantageous, however, to use those basic compounds which are not volatile at the temperatures during drying and/or curing, such as sodium hydroxide, potassium hydroxide or sodium carbonate, for example.

The abovementioned aqueous binders are advantageously suitable for use as binders for fibrous and granular substrates. With advantage, therefore, the aqueous binders stated can be used in the production of shaped articles from fibrous and granular substrates.

Fibrous and/or granular substrates are familiar to the skilled worker. Examples include wood chips, wood fibers, cellulose fibers, textile fibers, plastics fibers, glass fibers, mineral fibers or natural fibers such as jute, flax, hemp or sisal, but also cork chips or sand, and also other organic or inorganic, natural and/or synthetic, fibrous and/or granular compounds whose longest extent, in the case of granular substrates, is ≦10 mm, preferably ≧5 mm, and more particularly ≧2 mm. It will be appreciated that the term “substrate” is also intended to comprise the fiber webs obtainable from fibers, such as, for example, those known as needled fiber webs. With more particular advantage the aqueous binder of the invention is suitable as a formaldehyde-free binder system for the aforementioned fibers and for fiber webs formed from them.

The process for producing a shaped article from a fibrous and/or granular substrate and the aforementioned aqueous binder is advantageously performed by first impregnating the fibrous and/or granular substrate with the aqueous binder, bringing the impregnated substrate, if appropriate, into the desired shape, and subsequently drying the impregnated substrate and curing it at a temperature ≧130° C.

The impregnation of the fibrous and/or granular substrates is generally accomplished by applying the aforementioned aqueous binder uniformly to the surface of the fibrous and/or granular substrates. The amount of aqueous binder in this case is chosen such that ≧1 g and ≦100 g, preferably ≧2 g and ≦50 g, and with more particular preference ≧5 g and ≦30 g of binder, formed from the sum of polymer A and polyol B (reckoned as solids), are used per 100 g of fibrous and/or granular substrate. The impregnation of the fibrous and/or granular substrates is familiar to the skilled worker and takes place, for example, by drenching or by spraying of the fibrous and/or granular substrates.

Following impregnation, the fibrous and/or granular substrate is optionally brought into the desired form, by means, for example, of introduction into a heatable press or mold. Subsequently the shaped impregnated fibrous and/or granular substrate is dried and cured in a manner familiar to the skilled worker.

Frequently the drying and/or curing of the impregnated fibrous and/or granular substrate, which has been optionally brought into shape, takes place in two temperature stages, the drying stage taking place at a temperature <130° C., preferably ≧20° C. and ≦120° C., and with more particular preference ≧40 and 5100° C., and the curing stage taking place at a temperature of ≧130° C., preferably ≧150 and ≦250° C., and with more particular preference ≧180° C. and ≦220° C.

The drying stage in this case takes place advantageously such that drying at a temperature ≦100° C. is carried out until the shaped, impregnated fibrous and/or granular substrate, which frequently still does not have its ultimate shape (and is referred to as a semifinished product), has a residual moisture content ≦15%, preferably ≦12%, and with more particular preference ≦10% by weight. This residual moisture content is determined by first weighing the resulting semifinished product at room temperature, then drying it at 130° C. for 2 minutes, and subsequently cooling it and reweighing it at room temperature. In this case the residual moisture content corresponds to the difference in weight of the semifinished product before and after the drying operation, relative to the weight of the semifinished product before the drying operation, multiplied by a factor of 100.

The semifinished product obtained in this way is still deformable after heating to a temperature ≧100° C., and at that temperature can be brought into the ultimate shape of the desired shaped article.

The subsequent curing stage takes place advantageously such that the semifinished product is heated at a temperature ≧130° C. until it has a residual moisture content ≦3%, preferably ≦1%, and with more particular preference ≦0.5% by weight, the binder curing as a consequence of a chemical esterification reaction.

Frequently the shaped articles are produced by bringing the semifinished product into its ultimate shape in a shaping press, in the aforementioned temperature ranges, and subsequently curing it.

It will be appreciated, however, that it is also possible for the drying stage and the curing stage of the shaped articles to take place in one workstep, in a shaping press, for example.

The shaped articles obtainable by the process of the invention have advantageous properties, more particularly an improved tensile strength in the wet and/or hot state as compared with the prior-art shaped articles.

The invention is elucidated with reference to the following nonlimiting examples.

### EXAMPLES

### A. Preparation of the Polymer A

### Inventive Example 1 (I1)

A 2 I four-necked flask equipped with an anchor stirrer, reflux condenser, and two metering devices was charged at 20 to 25° C. (room temperature) with 200.0 g of methyl ethyl ketone (MEK) and 171.1 g of maleic anhydride (MAn) under a nitrogen atmosphere. Subsequently the initial-charge solution was heated to 82° C. with stirring, and, beginning simultaneously, feed stream 1 was metered in over the course of 5 hours and feed stream 2 over the course of 5.5 hours, both continuously and with constant volume flows. Thereafter the reaction mixture was polymerized at the aforementioned temperature for 2 more hours, after which the polymer solution obtained was cooled to room temperature.

### Feed Stream 1:

440.3 g acrylic acid (AA)
32.2 g dodec-1-ene, and
217.0 g MEK

### Feed Stream 2:

42.9 g a 75% strength by weight solution of t-butyl perpivalate in an aromatic-free hydrocarbon mixture (Akzo Nobel) and
183.7 g MEK

Subsequently 1000 g of the organic polymer solution obtained were diluted with 800 g of deionized water, and MEK was distilled off over 5 hours at a temperature of 110-115° C. under atmosphere pressure (1 atm=1.013 bar absolute) by introduction of steam. Thereafter a solids content of 54% by weight was set by addition of deionized water. The K value of the polymer A was found to be 19.1, and the weight-average molecular weight was found to be 13 100 g/mol.

The solids content was generally determined by drying a sample of approximately 1 g in a forced-air drying oven at 120° C. for two hours. Two separate measurements were carried out in each case. The figures reported in the examples are averages of the two results.

The K value of the polymer A was determined by the method of Fikentscher (ISO 1628-1) by means of a 1% strength by weight polymer solution.

The weight-average molecular weight of the polymer A was determined by means of gel permeation chromatography (linear column: Supremea M from PSS, eluent: 0.08 mol/l TRIS buffer pH 7.0, deionized water, liquid flow: 0.8 ml/min, detector: differential refractometer ERC 7510 from ERC).

### Inventive Example 2 (I2)

A 2 I four-necked flask equipped with an anchor stirrer, reflux condenser, and three metering devices was charged at room temperature with 200.0 g of MEK and 51.3 g of MAn under a nitrogen atmosphere. Subsequently the initial-charge solution was heated to 82° C. with stirring, and, beginning simultaneously, feed stream 1 was metered in over the course of 3 hours, feed stream 2 over the course of 5 hours, and feed stream 3 over the course of 5.5 hours, all three continuously and with constant volume flows. Thereafter the reaction mixture was polymerized at the aforementioned temperature for 2 more hours, after which the polymer solution obtained was cooled to room temperature.

### Feed Stream 1:

119.8 g MAn (in melted form)

### Feed Stream 2:

376.0 g AA
96.5 g 1-octene, and
217.0 g MEK

### Feed Stream 3:

42.9 g a 75% strength by weight solution of t-butyl perpivalate in an aromatic-free hydrocarbon mixture and
183.7 g MEK

Subsequently 1200 g of the organic polymer solution obtained were diluted with 700 g of deionized water, and water/MEK was distilled off on a rotary evaporator at a bath temperature of 80° C. until an internal pressure of 20 mbar (absolute) had been reached. Thereafter a solids content of 50% by weight was set by addition of deionized water. The K value of the polymer A was found to be 15.0, and the weight-average molecular weight was found to be 11 700 g/mol.

### Inventive Example 3 (I3)

Inventive example 3 was carried out in the same way as for inventive example 2, but using 343.8 g of AA, 128.7 g of 1-octene, and 217.0 g of MEK as feed stream 2.

Deionized water was added to set a solids content of 48.5% by weight. The K value of the polymer A was found to be 14.3, and the weight-average molecular weight was found to be 8300 g/mol.

### Comparative Example 1 (C1)

Comparative example 1 was prepared in the same way as for inventive example 1, but with the total monomer amount and the AA/MAn ratio (2.57) kept constant, with the inclusion of 181.1 g of MAn in the initial charge to the polymerization vessel, and with feed stream 1 composed exclusively of 463.5 g of AA and 217.0 g of MEK.

Deionized water was added to set a solids content of 42.5% by weight. The K value of the polymer A was found to be 17.2, and the weight-average molecular weight was found to be 11 100 g/mol.

### Comparative Example 2 (C2)

Comparative example 2 was prepared in the same way as for inventive example 2, but with the total monomer amount and the AA/MAn ratio (2.20) kept constant, with the inclusion of 201.3 g of MAn in the initial charge to the polymerization vessel, and with feed stream 1 composed exclusively of 442.3 g of AA and 217.0 g of MEK.

Deionized water was added to set a solids content of 44.2% by weight. The K value of the polymer was found to be 16.8, and the weight-average molecular weight was found to be 15 200 g/mol.

### Comparative Example 3 (C3)

Comparative example 3 was prepared in the same way as for inventive example 3, but with the total monomer amount and the AA/MAn ratio (2.01) kept constant, with the inclusion of 213.9 g of MAn in the initial charge to the polymerization vessel, and with feed stream 1 composed exclusively of 429.7 g of AA and 217.0 g of MEK.

Deionized water was added to set a solids content of 42.7% by weight. The K value of the polymer was found to be 16.7, and the weight-average molecular weight was found to be 14 900 g/mol.

### B. Performance Investigations

Glass fiber webs measuring 32×28 cm, with a basis weight of 60 g/m², from Schuller GmbH, Wertheim, were used.

The aqueous polymer solutions I1 to 13 and also C1 to C3 obtained in accordance with the inventive and comparative examples were admixed at room temperature and with stirring with an amount of triethanolamine sufficient to make the aqueous solutions comprise 30 parts by weight of triethanolamine per 100 parts by weight of polymer. Added subsequently to these solutions, likewise at room temperature and with stirring, was 1 part by weight of 3-aminopropyltriethoxysilane, based on 100 parts by weight of binder, formed from the amounts of polymer and the triethanolamine (solid/solid), and the aqueous binder solutions obtained were diluted with deionized water to a solids content of 25% by weight. Thereafter the glass fiber webs were passed in longitudinal direction via a continuous PES sieve belt with a belt running speed of 60 cm per minute through the aforementioned 25% strength by weight aqueous binder liquors. Through subsequent suction removal of the aqueous binder, the wet add-on was set at 48 g/m² (corresponding to 12 g/m² binder, reckoned as solid). The impregnated glass fiber webs obtained in this way were dried/cured in a Mathis oven, on a plastic net support, either at 180° C. for 2 minutes or at 200° C. for 2 minutes, with the maximum hot-air flow. After the webs had been cooled to room temperature, test strips measuring 240×50 mm were cut in the longitudinal direction of the fiber. The test strips obtained were then stored in a climate chamber at 23° C. and 50% relative humidity for 24 hours. The glass fiber web test strips obtained are referred to below, as a function of the polymer solution used for the aqueous binder, as test strips I1, I2, I3, C1, C2, and C3.

Determination of the tensile strength at 23° C.

The tensile strength was determined on a Zwick-Roell Z005 tensile testing machine. The test strips I1, I2, I3, C1, C2, and C3 were introduced vertically into a clamping device such that the free clamped-in length was 200 mm. Subsequently the clamped-in test strips were pulled apart in opposite directions at a speed of 25 mm per minute until the test strips tore. The higher the force needed to tear the test strips, the better the evaluation of the corresponding tensile strength. 5 measurements were carried out in each case. The figures reported in Table 1 represent in each case the average of these measurements.

### Determination of the Wet Tensile Strength

The wet tensile strength was determined in the same way as the tensile strength, at 23° C., with the difference that the respective test strips were stored in deionized water at 80° C. for 15 minutes first, and excess water was dabbed off with cotton fabric prior to measurement. The results obtained are likewise compiled in Table 1.

TABLE 1
compilation of the results

| | Curing at 180° C. | | Curing at 200° C. | |
|---|---|---|---|---|
| | Tensile strength | Wet tensile | Tensile strength | Wet tensile |
| Test | 23° C. | strength | 23° C. | strength |
| strip | [N/50 mm] | [N/50 mm] | [N/50 mm] | [N/50 mm] |
| I1 | 217 | 113 | 213 | 166 |
| I2 | 215 | 138 | 212 | 168 |
| I3 | 212 | 142 | 211 | 161 |
| C1 | 194 | 86 | 187 | 132 |
| C2 | 198 | 83 | 198 | 139 |
| C3 | 189 | 82 | 198 | 142 |

From the results it is clearly apparent that the test strips obtained using the aqueous binders of the invention exhibit a markedly improved tensile strength and wet tensile strength behavior.

1. An aqueous binder for fibrous and/or granular substrates comprising
a) an addition polymer A obtained by free-radical polymerization of
0.1% to 40% by weight of at least one C3 to C30 alkene (monomer A1),
40% to 99.9% by weight of at least one ethylenically unsaturated C3 to C6 monocarboxylic acid (monomer A2),
0% to 50% by weight of at least one ethylenically unsaturated C4 to C12 dicarboxylic acid and/or of the ethylenically unsaturated dicarboxylic monoalkyl esters or dicarboxylic anhydrides obtainable from said acid (monomer A3), and
0% to 30% by weight of at least one other ethylenically unsaturated compound which is copolymerizable with the monomers A1 to A3 (monomer A4),
the monomers A1 to A4 adding up to 100% by weight, and
b) a polyol compound having at least 2 hydroxyl groups (polyol B).

2. The binder according to claim 1, the weight ratio of polymer A to polyol B being 1:10 to 100:1.

3. The binder according to claim 1, the polymer A having been obtained by free-radical polymerization of
1% to 25% by weight of monomers A 1,
50% to 89% by weight of monomers A2, and
10% to 40% by weight of monomers A3.

4. The binder according to claim 1, the monomers A1 being selected from 1-alkenes having 6 to 18 carbon atoms.

5. The binder according to claim 1, the monomers A2 being selected from acrylic acid, methacrylic acid, ethyl acrylic acid, allyl acetic acid, crotonic acid and/or vinyl acetic acid.

6. The binder according to claim 1, the monomers A3 being selected from maleic anhydride, methylmaleic anhydride, maleic monomethyl ester, itaconic acid, itaconic anhydride, 1,2,3,6-tetrahydrophthalic acid and/or 1,2,3,6-tetrahydrophthalic anhydride.

7. The binder according to claim 1, the polymer A having a weight-average molecular weight ≧3000 g/mol and ≦40 000 g/mol.

8. The binder according to claim 1, the polymer A having a glass transition temperature ≧20 and ≦105° C.

9. The binder according to claim 1, the polyol B being an alkanolamine compound.

10. The binder according to claim 1, the polyol B being selected from diethanolamine, triethanolamine, diisopropanolamine, triisopropanolamine, methyldiethanolamine, butyldiethanolamine and/or methyldiisopropanolamine.

11. The binder according to claim 1, the amounts of polymer A and polyol B being chosen so that the ratio of the number of equivalents of carboxyl groups of the polymer A to the number of equivalents of hydroxyl groups of the polyol B is 100:1 to 1:3.

12. An addition polymer A obtained by free-radical polymerization of
0.1% to 40% by weight of at least one C3 to C30 alkene (monomer A 1),
40% to 99.9% by weight of at least one ethylenically unsaturated C3 to C6 monocarboxylic acid (monomer A2),
0% to 50% by weight of at least one ethylenically unsaturated C4 to C12 dicarboxylic acid and/or of the ethylenically unsaturated dicarboxylic monoalkyl esters or dicarboxylic anhydrides obtainable from said acid (monomer A3), and
0% to 30% by weight of at least one other ethylenically unsaturated compound which is copolymerizable with the monomers A 1 to A3 (monomer A4),
the monomers A 1 to A4 adding up to 100% by weight.

13. An aqueous binder comprising
0.1% to 40% by weight of at least one C3 to C30 alkene (monomer A 1),
40% to 99.9% by weight of at least one ethylenically unsaturated C3 to C6 monocarboxylic acid (monomer A2),
0% to 50% by weight of at least one ethylenically unsaturated C4 to C12 dicarboxylic acid and/or of the ethylenically unsaturated dicarboxylic monoalkyl esters or dicarboxylic anhydrides obtainable from said acid (monomer A3), and
0% to 30% by weight of at least one other ethylenically unsaturated compound which is copolymerizable with the monomers A1 to A3 (monomer A4),
the monomers A1 to A4 adding up to 100% by weight, and
b) a polyol compound having at least 2 hydroxyl groups (polyol B).

14. A process for producing a shaped article from a fibrous and/or granular substrate and an aqueous binder, which comprises first impregnating the fibrous and/or granular substrate with an aqueous binder according to claim 13, bringing the impregnated substrate, optionally, into the desired shape, and subsequently drying the impregnated substrate and curing it at a temperature ≧130° C.

15. The process according to claim 14, wherein the amount of aqueous binder is chosen so that ≧1 g and ≦100 g of binder, formed from the sum of polymer A and polyol B (calculated as solid), are used per 100 g of fibrous and/or granular substrate.

16. A shaped article obtainable by a process according to claim 14.
